(19) United States
(12) Patent Application Publication
(10) Pub. No.: US 2007/0247772 A1
(43) Pub. Date: Oct. 25, 2007

(54) ESD CLAMP CONTROL BY DETECTION OF POWER STATE

(75) Inventors: Bart Keppens, Gistel (BE); Benjamin Van Camp, Antwerp (BE); Aagje Bens, Geel (BE); Pieter Vanysacker, Pittem (BE); Steven Thijs, Willebroek (BE)

Correspondence Address: PATENT DOCKET ADMINISTRATOR;LOWENSTEIN SANDLER P.C., 65 LIVINGSTON AVENUE, ROSELAND, NJ, 07068, US

(73) Assignees: SARNOFF CORPORATION, Princeton, NJ (US); SARNOFF EUROPE BVBA, Gistel (BE)

(21) Appl. No.: 11/737,469

(22) Filed: Apr. 19, 2007

Related U.S. Application Data
(60) Provisional application No. 60/794,078, filed on Apr. 21, 2006.
(60) Provisional application No. 60/794,297, filed on Apr. 21, 2006.

(51) Int. Cl. H02H 9/00

(52) U.S. Cl. 361/56

(57) ABSTRACT

The present invention provides an improvement on ESD protection circuitry by controlling the trigger circuit to prevent the unwanted triggering of the device. The circuitry includes an ESD clamp with a trigger circuit coupled to the clamp. Both the clamp and the trigger circuit are coupled to a first reference potential. The circuitry also includes a control line coupled to the trigger circuit. The control line is coupled to a second reference potential to further control the behavior of the trigger circuit such that when the power is supplied to the second reference potential, the control line disables the trigger circuit, and when power is not supplied to the second reference potential, the control line enables the trigger circuit.

### CROSS-REFERENCE TO RELATED APPLICATIONS

This application claims the benefit of U.S. Provisional Application No. 60/794,078 filed on Apr. 21, 2006, and U.S. Provisional Application No. 60/794,297 filed on Apr. 21, 2006, both of which are incorporated herein by reference in their entirety.

### FIELD OF THE INVENTION

This invention generally relates to the field of electrostatic discharge (ESD) protection circuitry and, more specifically, improvements in controlling the triggering circuit in the protection circuitry of the integrated circuit (IC).

### BACKGROUND OF THE INVENTION

In order to protect sensitive nodes in IC's against ESD stress, ESD clamps need to be placed at certain points in the circuit. An important part of an ESD clamp is the trigger device. The trigger device will detect an ESD event and turn on the ESD clamp. The trigger device can be used in combination with any ESD clamp such as a MOS, SCR or another ESD-clamp.

Many different topologies exist for building trigger devices. One such example is shown in a prior art implementation of a circuit 100 of a power protection clamp based on RC time constant triggering as illustrated in FIG. 1. The circuit 100 comprises an ESD-clamp, which is a MOS transistor, MP 102 used in active mode to conduct the current. This large MOS device, MP 102 is connected (drain-source) in between a first voltage 104, preferably a Vdd supply line and a second voltage 106, preferably a Vss supply line. This large MOS device 102 or combination referred above, is called the main ESD clamp or protection element. A resistor (R1) 108 is connected between the gate of the ESD MOS device 102 and the first voltage 104. The circuit 100 also comprises of another MOS device (MN) 110, the source of which is connected to the gage terminal of the ESD MOS device 102. The trigger circuit comprises of the capacitor C 112 and the resistor R2 114, provided at the gate terminal of the ESD MOS clamp 102 and the MOS device 110. As such, the MOS gate signal is typically directly or indirectly derived from an RC timer circuit consisting of a (MOS) capacitance 112 and a (MOS) resistor 114.

The time constant for this RC filter scheme depends on the actual values of the R 110 and C 108 elements. Prior art implementations typically have time constant in the order of 50 ns-5 us. The main idea for this methodology is such that the ESD protection clamp, 102 is in conductive mode during ESD stress, when the voltage on the VDD line 104 rise fast enough (faster than in the range of 50 ns-5 us). This ensures good ESD protection during handling and transport of the chips.

When the chip, i.e. the ESD protection clamp 102, the MOS device 112 and the resistance R(20) 114 is wired on the PCB board and powered up in the system, the capacitance C 112 from the RC filter is charged up and MOS clamp 110 is turned off, OFF signal to the main ESD clamp 102. When fast voltage/current pulses are injected on the supply line during on-state of the chip, the voltage over the capacitance, C 1112 can change, which can lead to an ON-signal for the MOS clamp device 110 and this can bring the main MOS ESD clamp 102 in a conductive state, reducing the supply voltage for a short amount time. Thus, these fast pulses can trigger the power clamp 102 into a conductive state which is unwanted during normal operation as will be illustrated with reference to FIGS. 2 and 3 below.

Referring to FIG. 2, there is shown a prior art implementation of the circuit 100 of FIG. 1 including a load change 201 seen by a output driver 202 defined by circuitry placed at the output pad 204 (internal or external) of a Chip 206. When the load change 201 from one value to another value, current will flow through the output driver 202 and thus the power supply, Vdd 104 will not be constant, i.e. stable anymore and there is some spike introduced at the power supply. If the power supply, Vdd 104 is no longer stable, this is seen by the trigger element (C 112 and R 114) of the ESD clamp 102 of circuit 100 as a fast event and thus defined as ESD event. The trigger element will turn the main ESD clamp 102 in an on state, introducing current flow through the ESD clamp 102. This current is unintended and unwanted for normal operation. FIG. 2A depicts a graphical illustration of the voltage and current pulses based on the load change of FIG. 2.

Referring to FIG. 3, there is shown a prior art implementation of the circuit 100 of FIG. 1 with also a current flow through the output driver 202, resulting in an unstable VDD powerline 104, but now introduced by the switching of the output driver 202. Similar to FIG. 2, the driver state change will cause the leakage current to flow into the ESD MOS clamp 102 during normal state. FIG. 3A depicts a graphical illustration of the voltage and current pulses based on the load change by internal switches 302 of FIG. 3. The effects described in FIGS. 2 and 3 above can also occur in drivers completely internal in the chip, but this is less possible since the current capability of these drivers is much less.

Although attempts have been made in the past to reduce the time constant by different circuit techniques, there still exist a danger for unwanted triggering of the device during normal supply line powered operation.

### BRIEF DESCRIPTION OF THE DRAWINGS

FIG. 1 depicts an illumination of a circuit diagram of a prior art implementation of a power protection clamp based on RC time constant triggering.

FIG. 2 depicts an illustration of a circuit diagram of a prior art implementation of a load change.

FIG. 2A depicts a graphical illustration of the voltage and current pulses based on the load change of FIG. 2.

FIG. 3 depicts an illustration of a circuit diagram of a prior art implementations of a load change.

FIG. 3A depicts a graphical illustration of the voltage and current pulses based on the load change of FIG. 3.

FIG. 4 depicts an illustration of a block diagram of a control of the ESD Clamp/trigger element in one voltage domain in accordance with one embodiment of the present invention.

FIG. 5 depicts as illustration of a block diagram of a power protection clamp for two voltage domains in accordance with another embodiment of the present invention.

FIG. 6 depicts an illustration of a block diagram of the trigger circuit of FIG. 5.

FIG. 7 depicts an illustration of the circuit diagram of the trigger circuit of FIG. 5.

FIG. 8 depicts an illustration of the circuit diagram of the power protection clamp of FIG. 7 used in the simulations.

FIG. 8A depicts a graphical plot illustrating the simulation results of capacitor of 200 fF of FIG. 8.

FIG. 8B depicts a graphical plot illustrating the simulation results of capacitor of 250 fF of FIG. 8.

FIG. 8C depicts a graphical plot illustrating the simulation results of capacitors of various sizes of FIG. 8.

FIG. 9 depicts an illustration of a circuit diagram of the block diagram of the power protection clamp of FIG. 5 for low voltage domain in accordance with another embodiment of the present invention.

FIG. 10 depicts an illustration of a circuit diagram of the supply noise immune active clamp circuit in accordance with one embodiment of the present invention.

FIG. 11 depicts an illustration of a circuit diagram of the supply noise immune active clamp circuit in accordance with another embodiment of the present invention.

FIG. 12 depicts an illustration of a circuit diagram of the supply noise immune active clamp circuit with transient control of the disconnection switch in accordance with another embodiment of the present invention.

FIG. 12A depicts a graphical plot illustrating the voltage behavior of the circuit of FIG. 15 during power-up.

FIG. 12B depicts a graphical plot illustrating the current behavior of the circuit of FIG. 15 during power-up.

FIG. 13 depicts an illustration of a circuit diagram of the supply noise immune active clamp circuit with minimum voltage control of the disconnection switch in accordance with an alternate embodiment of the present invention.

FIG. 14 depicts an illustration of a circuit diagram of the supply noise immune active clamp circuit with maximum voltage control of the disconnection switch in accordance with an another alternate embodiment of the present invention.

FIG. 15 depicts an illustration of a circuit diagram of the supply noise immune active clamp circuit using the state of another voltage domain to control the disconnection switch with even further embodiment of the present invention.

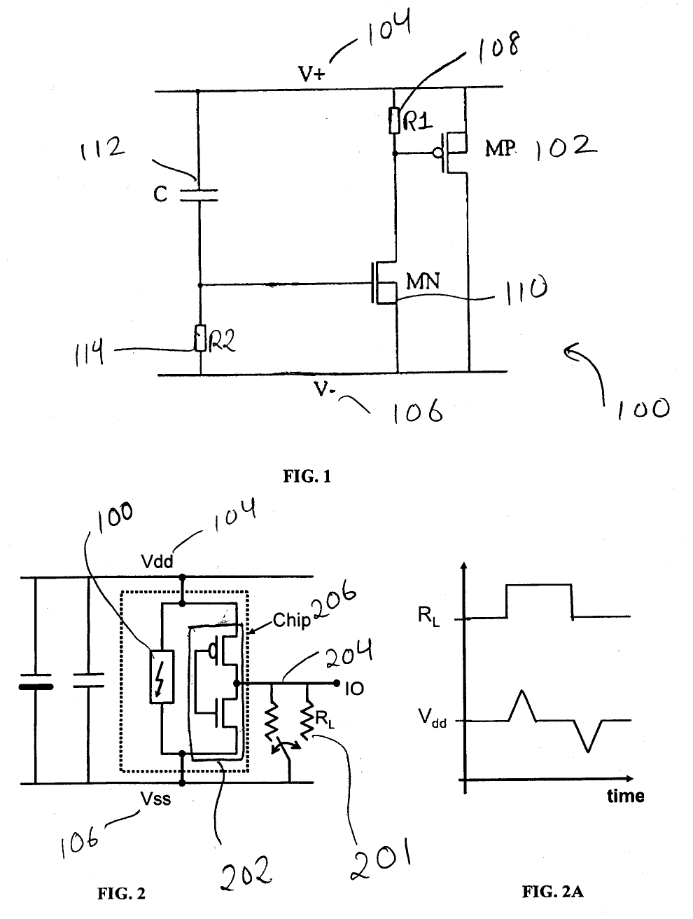

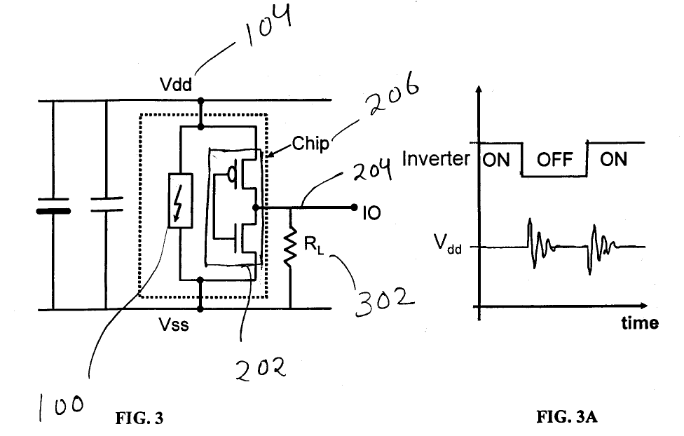

### SUMMARY OF THE INVENTION

The present invention provides an ESD protection circuit comprising an ESD clamp, a trigger circuit coupled to the clamp. The clamp and the trigger circuit are coupled to a first reference potential. The circuit further comprises a control line coupled to the trigger circuit. The control line is coupled to a second reference potential. So, when power is supplied to the second reference potential, the control line disables the trigger circuit, and when power is not supplied to the second reference potential, the control line enables the trigger circuit.

### DETAILED DESCRIPTION OF THE INVENTION

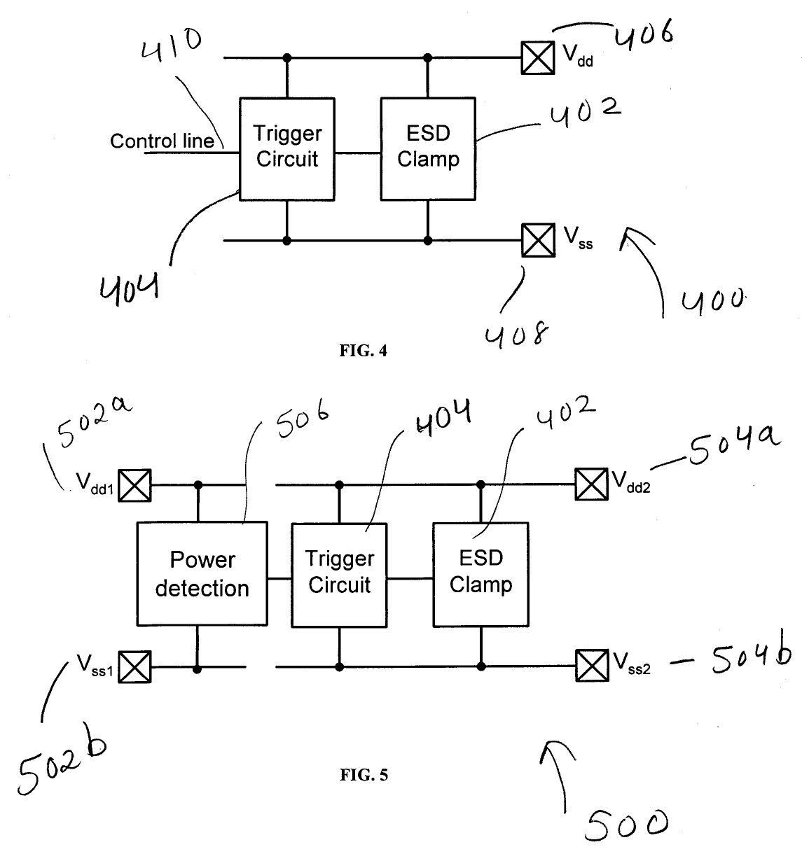

Referring to FIG. 4, there is disclosed a block diagram 400 of a general view of the ESD Clamp/trigger element controlled by a control line in accordance with one embodiment of the present invention. The ESD clamp 402 is coupled to the trigger circuit/element 404 which together are coupled between a first reference potential, i.e. power line Vdd 406, which is the positive voltage supply and a second reference potential. i.e. power line Vss 408, which is preferably ground. Additionally, the control line 410 is added to the trigger circuit/trigger element 404 to control the trigger circuit. Preferably the control line is coupled to a second power line/supply(not shown). Note that in this particular case, this can be sufficient to trigger the ESD-clamp 402, since the trigger circuit 404 is a low resistive path between the second power supply and the main ESD clamp 402. However, in the general case described in FIG. 4, if the second power line is powered, i.e. voltage is applied via the control line 410 during normal operation (the “on state”), the control line 410 signals the trigger circuit 404 to turn off which in turn disables the ESD clamp 402. This will prevent the current flow, i.e. ESD current to go “on” state in a normal operation. If there is a noise at an input, which induces transient noise to the first power line, Vdd 406, the ESD clamp 402 will not trigger, since the trigger is positioned to another power line (where there is less noise). However, when no power is applied (the “off” state), the trigger circuit 404 turns on which in turn enables the ESD clamp 402 to be in an active mode or be able to trigger during an ESD event. This approach enables the ESD of ESD protection clamps for very small or even negative design windows in certain voltage domains. For very small or even negative design windows it is very difficult to use a ESD element that will turn on if a certain voltage (trigger voltage) is reached, since the designing window is too small. When the second power line is turned off, the trigger circuit triggers at very low voltage.

Note in one embodiment of the present invention, the trigger circuit 404 of FIG. 4 is comprising preferably at least one MOS device. The trigger circuit 404 enables the ESD clamp 402 if the voltage at the control line 410 is for example below the threshold voltage of the MOS. If the voltage at the control line 410 is higher than the threshold voltage of the MOS, the trigger circuit 404 disables the ESD clamp 402.

For IC's with multiple voltage domains, the order in which the different voltage domains should be powered can be preferably assigned during normal operation. Preferably, the state of the voltage domain that needs to be powered first can be used to turn on or off the ESD protection clamps on other voltage domains of the IC. Similarly, the voltage domain that is powered up second, can be used to turn on or off the ESD protection clamps on other voltage domains of the IC, except the first etc. The generic form with multiple voltage domains consist of a small circuit on the IC that enables or disables ESD protection clamps in certain voltage domain(s), according to the current state of other voltage domain(s). An example of such a generic block circuit 500 is illustrated in FIG. 5 having two different voltage domains, i.e. Vdd1-Vss1 (Vdd1 voltage domain) 502 which comprises Vdd1 502a and Vss1 502b and Vdd2-Vss2 (Vdd2 voltage domain) t04 which comprises Vdd2 504a and Vss2 504b. In this example the Vdd1 voltage domain 502 is specified to be powered first during normal operation, and the Vdd2 504 voltage domain is powered thereafter. Thus, the voltage level on Vdd1 voltage domain 502 is used to define the state of the ESD clamp in Vdd2 voltage domain 504. The generic block circuit 500 comprise mainly of three parts, the power detection 506 which detects whether Vdd1 voltage domain 502 is powered up. In its simplest form, the power detection 506 in a short between Vdd1 502a and the input of the trigger circuit 404. The trigger circuit block 404 is coupled to the power detection 506 which uses the signal from the power detection block 506 to allow or to not allow the ESD clamp 402 to turn on. It is this ESD clamp 402 which will dissipate the actual ESD energy. In short, the condition whether a certain supply voltage is applied to Vdd1 voltage domain 502, prevents the trigger circuit 404 from triggering the ESD clamp 402 on the Vdd2 voltage domain 504, or in other words turning off the ESD clamp 402.

In one state, not during normal operation, when the power is off, i.e. the first voltage domain Vdd1 502 (between the Vdd1 502a and Vdd2 502b) is at 0 voltage, and there is an ESD event at the second voltage domain Vdd2 504 (between the Vdd2 504 and Vss2 504b). In this state, the power detection circuit 506 will also output 0 voltage which is the input to the trigger circuit 404. This trigger circuit 404 is designed to pick up the ESD event at the second voltage domain Vdd 504 when the input of the control line 410 is 0 voltage. This cause the trigger circuit 404 to go in the “on” state, thus providing at the output a high voltage, which is a trigger signal to trigger the ESD clamp 402.

In another state, when power is on, for example, 1.2 volts at the first voltage domain Vdd1 502 and there is an ESD event at the second voltage domain Vdd2 504 which is for example about 1.8 volts. Then the output of the power detection circuit 506 has a high voltage, i.e. 1.2 volts, which is the input to the trigger circuit 404 which in turn will give out low voltage at its output to turn off the ESD clamp 402. Note that this is one example of providing a high output at the trigger circuit 404, other implementations can be created that will give a high output at the trigger circuit 404 to turn off the main ESD clamp 402. Also, the trigger circuit 404 to provide a low output while receiving a high input may preferably comprise at least one inverter (not shown). The trigger circuit 404 as described may preferably be a short (not shown) which will not be able to detect the ESD event at the second voltage domain 504 or preferably a RC based trigger circuit (not shown) which will be able to detect the ESD event at the second voltage domain. Furthermore, the trigger circuit may preferably also comprise a combination of inverters etc. Thus, many different embodiments of the trigger circuit will be described in greater detail below.

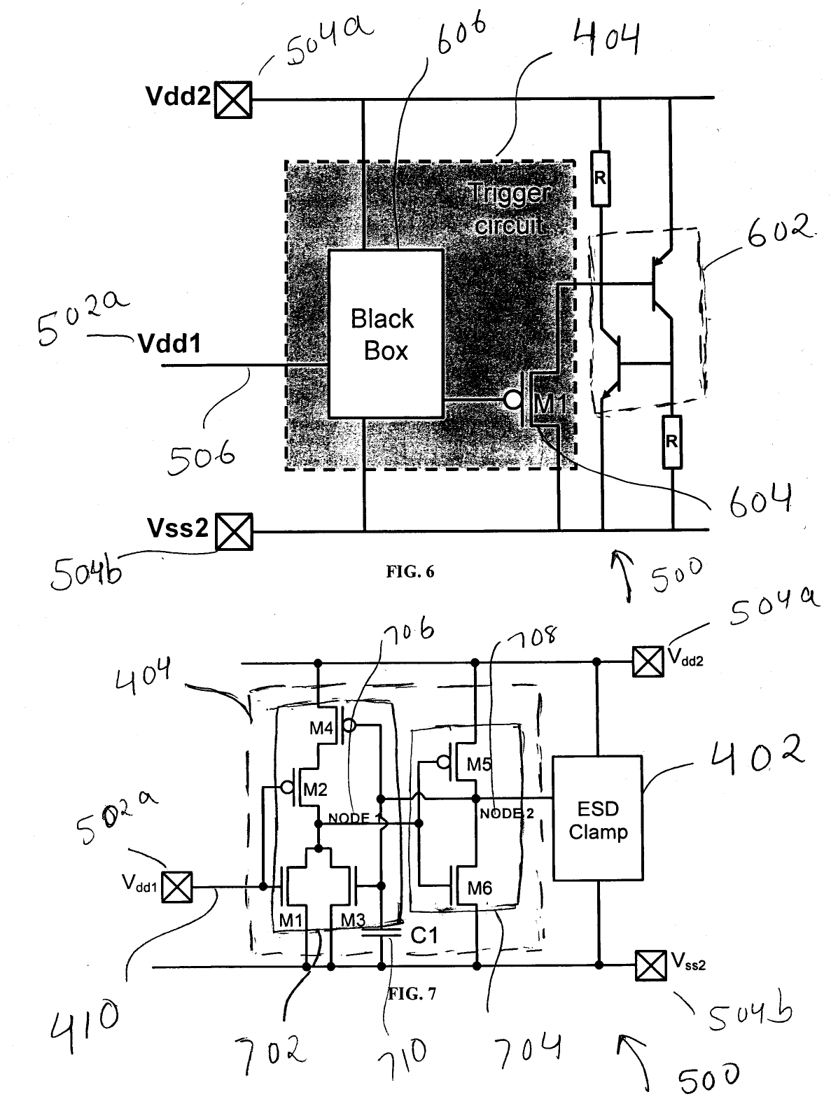

One embodiment of the power detection circuit 506 is illustrated in FIG. 6. In FIG. 6, the power detection 506 is implemented as the connection from the Vdd1 502a to the trigger circuit 404 and the ESD clamp 402 is implemented as an SCR 602. The trigger circuit 404 in FIG. 6 is illustrated as comprising two parts, a PMOS 604 which will feed the ESD current to the ESD clamp 602, and a black box 606, which regulates the gate of the trigger PMOS 604. During ESD, when there is no power at the Vdd1 502a and at Vdd2 504a, PMOS 604 is at an ON State, the power detection circuit 506 gives 0 voltage output, which is the input into the black box 606. This causes the black box 606 to keep the gate voltage to the PMOS 604 at low level during ESD. A low level at the gate of the PMOS 604 enables during ESD to trigger the clamp 602. When the power is on, normal operation, at the Vdd line 502a, and there is an ESD event at the Vdd2 504a the power detection circuit 506 gives out high voltage output which is the input into the black box 606. This causes the black box 606 to keep a high voltage at the gate of the PMOS 604, turning it in a OFF state and thus disabling the ESD clamp 602. Thus, the black box 660 can preferably be at least some inverter circuit that transform the voltage from its input to an appropriate voltage to control the PMOS 604.

FIG. 7 depicts an illustration of the circuit diagram of the trigger circuit 404 of FIG. 5 in a preferred embodiment of the present invention. In this diagram, the power detection 506 is also implemented as the control line 410 connecting from the Vdd1 502a to the trigger circuit 404. The trigger circuit 404 is basically a combination of capacitor 710, logic OR gate 702 with the output fed back to one of its inputs and an inverter 704. The logic OR gate 702 comprises transistors M1, M2, M3 and M4 and the inverter 704 comprises transistors M5 and M6 as illustrated in FIG. 7. Node1 706 is illustrated as the output of the drain of the transistor M1 which provides the signal into the inverter 704. Node2 708 is the output of the inverter 704 which provides the trigger signal into the ESD clamp 402.

Under normal operation, if the voltage is applied at the Vdd1 domain, 502, Vdd1 502a is at “ON” state, i.e. voltage is first applied on Vdd1 502a, which will turn transistor M1 ON and turn OFF transistor M2. This will cause the drain voltage of M1 to pull the Node1 706 to Vss2, which is 0 volts. Thus, Node1 706 is controlled by the voltage at Vdd1 502a. The voltage signal of Node1 706 is the input to the inverter 708 which in turn pulls Node2 708 to the Vdd2 504a voltage, i.e. high voltage, since Node2 708 is the output of the inverter 704. The high voltage at Node2 708 will signal to turn off the ESD clamp 402 and thus the clamp 402 will not trigger. Note that if Vdd1-Vss1 is a low voltage domain and Vdd2-Vss2 is a high voltage domain, low voltage transistor types can be used for both the input transistors M1 and M2, as well as high voltage types, Also, if Vdd1-Vss1 is a high voltage domain and Vdd2-Vss2 is a low voltage domain, high voltage transistor types can be used for both the input transistors M1 and M2, as well as low voltage types.

During ESD, all power is turned off at the first voltage domain, i.e., Vdd1 502a and a ESD stress is now applied to the second voltage domain, Vdd2 504a, i.e., Vdd2 504a is in the “ON” state, causing Node1 706 to be no longer controlled by Vdd1 502a because the transistor M1 is turned OFF. However, the voltage at Vdd2 504a is increasing and will continue to increase. Due to the capacitance. 710 the node 2 will be pulled initially to Vss2 504b, M3 will be turned OFF and M4 will be turned on. The charging of the capacitance will be much slower than the rise of the voltage at the VDD2 504a line. This will introduce that the voltage of NODE2 is below the switching voltage of another inverter formed by M3 and M4. This will give a high voltage at Node 1. Since NODE 2 is the output of inverter 704 with the NODE 1 as input, this output will be a low voltage. This low voltage will make it possible to turn on the ESD clamp 402 during ESD. Note that due to the feedback connection, Node2 will remain at low voltage.

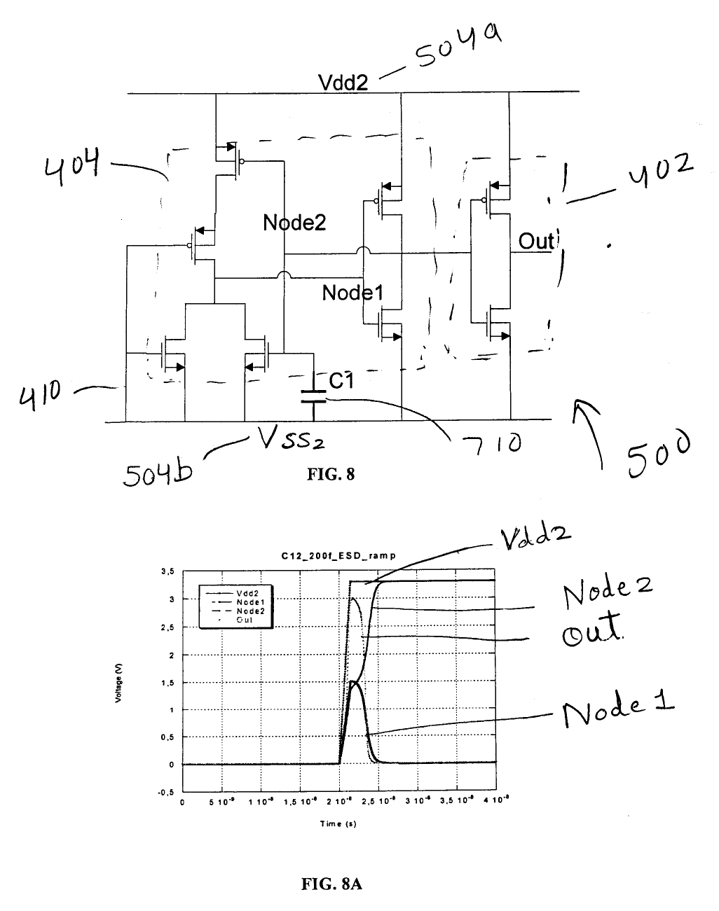

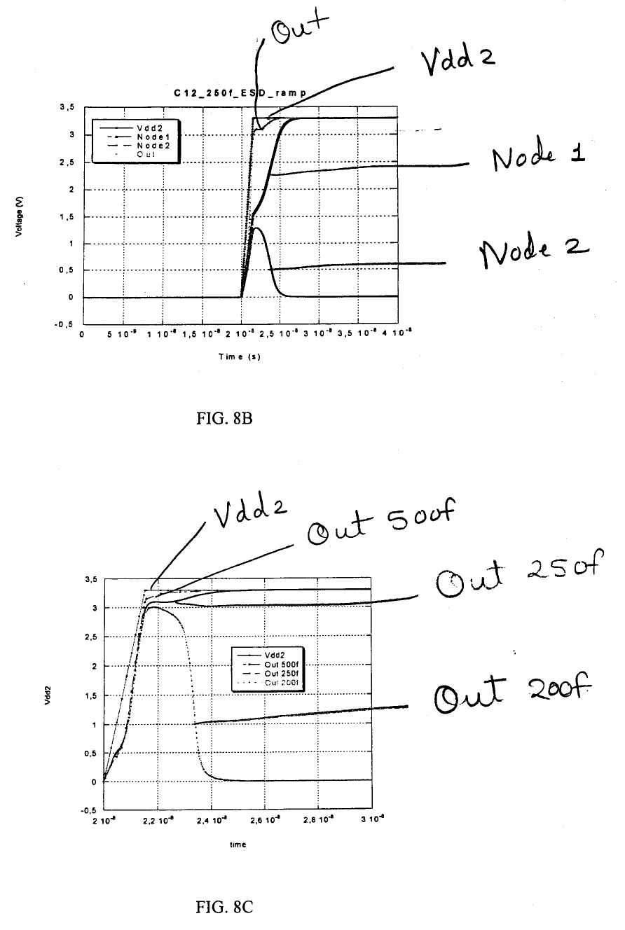

FIG. 8 depicts an illustration of the circuit diagram of the power protection clamp of FIG. 7 on which the simulations were performed. This circuit diagram is similar to FIG. 7 with ESD clamp 402 shown as a second inverter in a preferred embodiment of the present invention. However the control line 410 that is normally connected to Vdd1 502a, as shown in FIG. 7 is now connected to Vss2 504a, i.e. ground, as this first voltage domain is considered as unpowered as shown in FIG. 8. Furthermore, Vdd1 bus 502a (not shown) is coupled to the control line 410 and Vss1 502b (not shown) is coupled to Vss2 504b, thus the Vdd1 bus 502a (not shown) is coupled to ground by the capacitor C1 710, which is simulated by a short.

The results of the simulations are shown in FIG. 8A and FIG. 8B. FIG. 8A shows a graphical plot illustrating the simulation results of capacitor C1 710 of 200 fF of FIG. 8. FIG. 8B depicts a graphical plot illustrating the simulation results of Capacitor C1 710 of 250 fF of FIG. 8. Both simulations are done for a ramp up signal on Vdd2 with fast rise time to simulate an ESD discharge on Vd2 with respect to Vss.

The graph of FIG. 8A illustrates that initially Node1 rises, but is pulled low after a while, causing Node2 to become high. This situation is unwanted as this is the condition where the ESD clamp 402 doesn't trigger. Thus, as described above, the inverter (M5 and M6) 706 is placed behind Node2 to amplify and monitor the signal or Node2, which can be used to drive the ESD protection. The output of this inverter is displayed as the ‘Out’ signal. From this simulation is concluded that the capacitor C1 710 having a value of 200 fF is too small to invoke proper triggering during an ESD event on Vdd2 with a rise time as simulated.

The graph of FIG. 8B illustrates the situation where the capacitance value of C1 is large enough, i.e., the value is at 250 fF. During the ramp up of the Vdd2 signal, Node2 will rise, but slow down the pulse on the input of transistors M3 and M4. At a certain point, the inverter 704 (M5 and M6) will switch and its output Node2 708 will become low. Node1 706 in turn will be pulled high. The output of the second inverter which is the ESD clamp 402 will receive the input signal from the output Node2 708 and thus will now become high too (shown in the graph as ‘Out’). This condition is where the ESD protection gets triggered and clamps the voltage over Vdd2 504a to a safe value.

FIG. 8C depicts a graphical plot illustrating the simulation results of capacitors C1 of various sizes of FIG. 8. In the plot of FIG. 8C is a comparison of three different capacitance values for C1, i.e., 200 fF, 250 fF, 500 fF. It can be seen that the larger the capacitance, the faster the Out signal will clamp to Vdd2 and turn on the ESD protection. However, for more than 250 fF, there is not much difference seen in performance. The critical value where the capacitance gets too low for proper operation is somewhere between 200 and 250 fF for these simulations. For other technologies this value can be different. Thus, the preferred value of the capacitor C1 is 250 fF. However, it is noted that this value can differ for different technologies or transistor sizes.

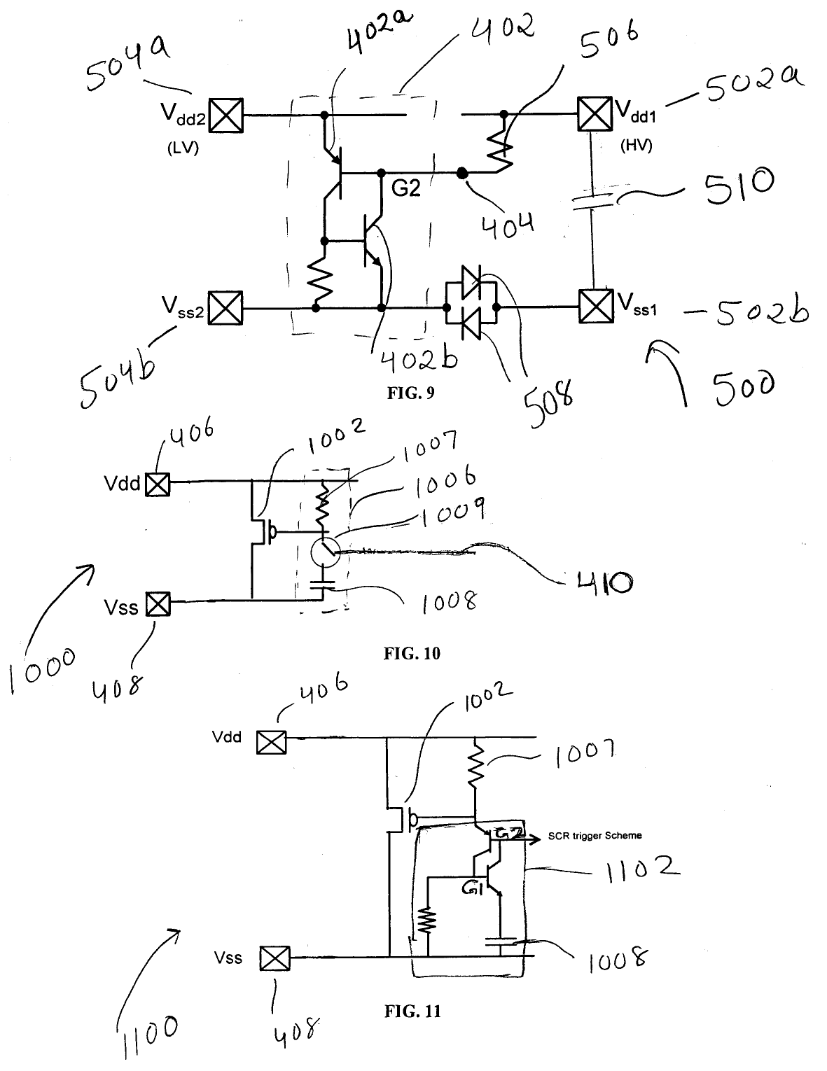

FIG. 9 depicts an illustration of a circuit diagram of the block diagram of the power protection clamp of FIG. 5, used as a power line protection for low voltage domain of an IC in accordance with another embodiment of the present invention. In this embodiment, the first voltage domain, i.e., Vdd1 502 is at a high voltage (HV) domain, whereas the second voltage domain, Vdd2 504 is at a low voltage (LV) domain. The ESD clamp in FIG. 9 of this embodiment is preferably the SCR comprising a PNP transistor 402a and NPN 402b transistor. The power detection block 506 comprises of a short or resistive connection between Vdd1 and the input of the trigger circuit 404. The trigger circuit 404 itself is a short between its input and G2 of the SCR 402. Thus, the ESD clamp 402 is connected to the power detection 506 without a physical trigger circuit since the trigger circuit 404 in this embodiment is simply a short. Therefore, the G2 trigger tap is connected to the Vdd1 line 502a of the first voltage domain Vdd2 502 which is the high voltage domain in this embodiment. The high voltage domain 502 is specified to be powered first under normal operation. Thus, during normal operation, i.e., no ESD event, power will be applied to Vdd1 502a (the high voltage domain first. The voltage at Vdd2 502b is much lower than the voltage at Vdd1 502a, thus the difference in voltage between Vdd2 502b and Vdd1 502a is at a negative value. Thus the SCR 402 will not trigger because in order for SCR 402 to trigger, the gate voltage at G2 has to be at least 0.7 volts. If the voltage over the Anode, i.e., Vdd2-G2 junction of the SCR 402 is larger than 0.7V the PNP 402a is turned on and current flow into the NPN 402b will create the feedback that will start the ESD operation of the device. If this voltage is lower, the PNP 402a is not turned on and will so not turn on the SCR 402 operation of the device. Since the chip capacitance will keep the Vdd1 502a close to the Vss1 502b voltage and since the voltage of Vdd2 504a rise (ESD event) above 0.7 volt, the difference between voltage at 402a and G2 will also be above 0.7 volts, triggering the device to operate in SCR mode, thus, providing a sufficient clamping between Vdd2 504a and Vss2 504b. The antiparallel diodes 508 are placed to establish a connection between both Vss lines, i.e., the Vss1 502b and Vss2 504b lines under ESD conditions. This is because there is a need for ESD protection between the Vss lines since the voltage difference during normal operation is very small, a diode can be sufficient to provide an ESD path. Thus, the two diodes 08 configured in back to back configuration as shown in FIG. 9 will provide a 2 way ESD protection.

When an ESD discharge occurs from Vdd2 504a to Vss1 504b, the voltage at Vdd2 504a is high and the voltage at Vdd1 502a is at 0 volts. G2 is coupled to Vdd1 502a and thus to Vss1 502b due to a chip capacitance 510 as shown in FIG. 9.

Referring to FIG. 10, there is shown an illustration of a circuit diagram of the block diagram of the power protection clamp 1000 of FIG. 5. The circuit diagram of FIG. 10 illustrates supply noise immune active clamp circuit 1000 in accordance with another embodiment of the present invention. The ESD clamp 402 is implemented preferably as a MOS device 1002 and the trigger circuit 404 is implemented preferably as the RC transient detector 1006 as shown in FIG. 10. Although in the figure the MOS device 1002 is shown as a PMOS, it is also possible to use this technique with an NMOS. The RC transient detector comprises a resistor (R) 1007 and a capacitor (C) 1008 and a switch 1009 connected to the C 1008 to control the connection of the supply line, Vdd to the C 1008. The control line is preferably connected to the switch 1009 as shown. In this embodiment, the supply noise issue can be prevented by isolating the capacitor, C 1008 from the supply line by the switch 1009 during powered state of the chip.

The ESD occurs between the Vdd line 406 and the Vss line 408 or may also occur for IO protection between IO (not shown) and the Vss 408 or between the Vdd 406 and the IO (not shown). During ESD, the switch 1009 is closed, i.e., in conductive state and the capacitor 1008 is connected in the RC filter 1006 creating a RC time constant for the power clamp as in the prior art. However during normal operation, with no ESD event, the capacitance 1008 is disconnected to the RC filter 1006 using the switch device 1009. The capacitor charge/voltage cannot change anymore when fast transients appear on the supply line, i.e. the Vdd line 406. This disconnection of the capacitor C 1008 from the Vdd line 406 will prevent triggering of the trigger circuit, i.e. RC detector 1006 due to fast change in the supply potential. Therefore, the switch 1009 is also commonly referred to as the “disconnection switch”. This naming is meant for clarification and is not meant to be limiting in any way. The switch device 1009 is very beneficial for many noisy applications like but not limited to automotive applications, power regulators, large display drivers. In most cases this switch is an active device, controlled by other circuitry on the chip

Note that even though in FIG. 10, the ESD clamp 402 is shown as the MOS transistor 1002, the ESD clamp can also preferably comprise, bipolar transistors, SCRs, diodes or any other device. To further explain the working principle of this embodiment invention, more examples are described below which do not limit the scope of the invention and are for clarification purposes only.

FIG. 11 depicts an illustration of a circuit diagram 1100 of the supply noise immune active clamp circuit in accordance with another embodiment of the present invention. This FIG. 11 is similar to FIG. 10 with the switch 1009 implemented as an SCR 1102. Triggering the SCR 1102 can be done in various ways. During normal operation the SCR 1102 will not trigger, this will disconnect the capacitor 1008. During ESD the SCR 1102 is turned on and will connect the capacitor 1008 to the gate of the PMOS 1002 (or in general to the ESD clamp 402). Note that since the cathode of the SCR 1102 is coupled to the capacitor, C 1008 the SCR 1102 does not create any latch up danger. In this example the SCR 1102 is G2 triggered. Other triggering scheme such as dual triggering or G1 triggering can be used. Another interesting fact is that the triggering of the SCR 1102 is not needed for the device to work as an ESD protection device. However, if the SCR 1102 is not triggered during ESD, the device width must be large enough, since its parasitic capacitance must be large enough. If the SCR 1102 triggers during ESD, the SCR size can be made smaller, since in this case it can be modeled as a diode (resistor in small signal equivalent).

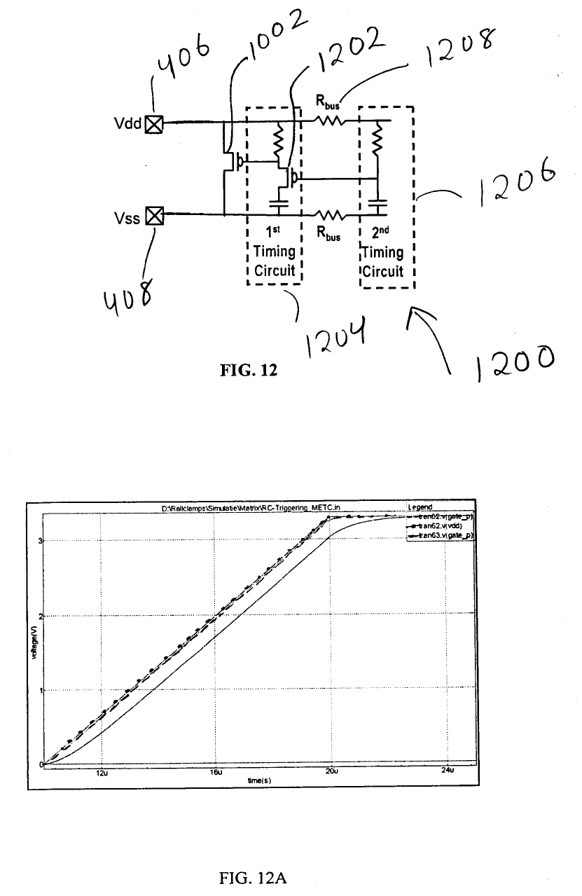

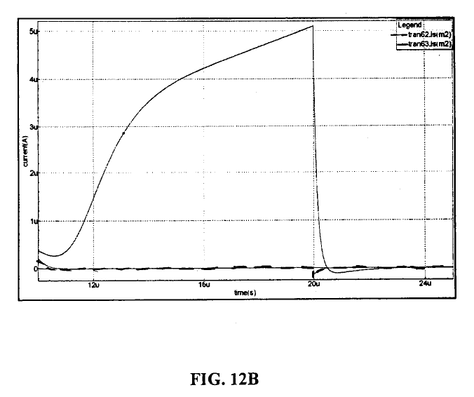

FIG. 12 depicts an illustration of a circuit diagram 1200 of the supply noise immune active clamp circuit in accordance with another embodiment of the present invention. This FIG. 12 is similar to FIG. 11 with the disconnection switch 1009 implemented as a first PMOS device 1202. Thus in this embodiment, the trigger circuit is the 1^{st} timing circuit 1204 comprising the R 1007, the C 1008 and the first PMOS device 1202. To control the gate of the disconnection switch, i.e. the first PMOS device 1202, many possibilities exists. A transient control i.e. a 2^{nd} timing circuit 1206 is added and connected to the same control line as the ESD switch 1202. The 2^{nd} timing circuit 1206 is one preferred embodiment of the power detection circuit 506 of FIG. 5. There are many advantages for using this circuitry. First, the 2^{nd} timing circuit 1206 can be tuned for a different time constant as the 1^{st} timing circuit 1204. Second, the connection of the 2^{nd} timing circuit 1206 can be at a different place on the Vdd line 406, in other words, there can be a large has resistance, Rbus 1208 as shown, between both the timing circuits. This avoids triggering of the ESD clamp the PMOS 1002, duet to a local noise event. When power is on during the normal operation, there is no ESD event, 2^{nd} timing circuit will detect the high voltage in Vdd line 406 and will remember that the power is on. This 2^{nd} timing circuit 1206 will then turn off or disable the first PMOS device 1202 in the 1^{st} timing circuit 1204 which in turn will not provide a trigger signal to the ESD clamp, the PMOS 1002. When power is off, during ESD event, (the voltage at Vdd line 406 is 0 volts, the 2^{nd} timing circuit 1206 will not be able to detect this 0 volts in Vdd line 406. Thus, the 1^{st} timing circuit 1204 will detect this ESD event, and will turn on the first PMOS device 1202 to provide a trigger signal to the ESD clamp, i.e., PMOS 1002. Please note that a disconnection switch can also preferably be added in the 2^{nd} timing circuit and control of the same will be applied similarly to the disconnection switch in the 1^{st} timing circuit.

To prove the functionality of the invention, there were some simulations performed on the circuit of FIG. 12 described above. FIG. 12A depicts a graphical plot illustrating the voltage behavior of the circuit of FIG. 12 during power-up or on state. So, when the power is on during normal operation, i.e. Vdd voltage is applied to the IC, the ESD driver, i.e., the first PMOS 1202 stays in OFF state. This means that the potential at the gate of this first PMOS 1202 has to be as close as possible to the potential of the power line. So, during power up, the gate potential has to follow the Vdd line 406. If the difference of the two voltages becomes too large, the first PMOS 1202 starts to conduct some current. In the graph, the dotted line depicts the potential on the Vdd-line 406. The dashed line curve indicates the simulated behavior of the invention. The solid line depicts the simulated behavior of the conventional prior art power clamp. The solid line and the dashed lines show the voltage delivered to the ESD clamp (in this case the PMOS 1002) during power up. It is clear that the gate with the invention i.e. the dashed line follows the behavior of the power supply, which is the dotted line (Vdd line). The voltage over the source and gage of the PMOS 1002 will be very small, so keeping the PMOS 1002 in an off state. If we look at the conventional approach which is the solid line, this voltage is no longer small. This will turn on the PMOS during normal operation (power up in this simulation).

FIG. 12B depicts a graphical plot illustrating the current behavior of the circuit of FIG. 12 during power-up. As you can see, the current, as shown by the dashed line, through the power clamp of the present invention, (i.e. the whole circuit of FIG. 12 including the PMOS 1002, the first timing circuit 1204 and the second timing circuit 1206) is much lower during power up that with an older technique which is the solid line.

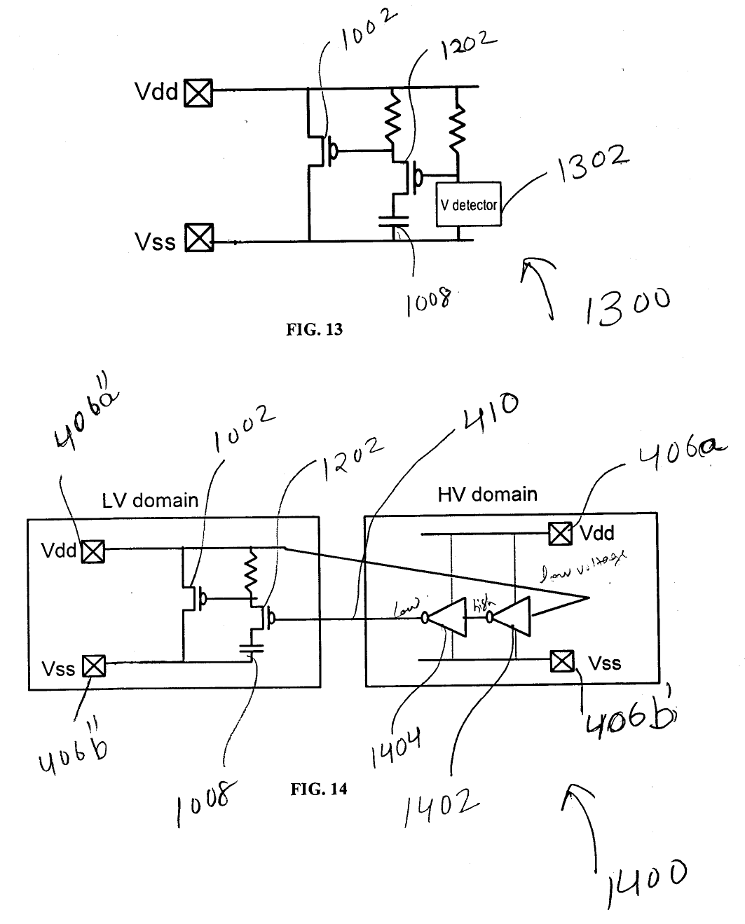

FIG. 13 depicts an illustration of a circuit diagram 1300 of the supply noise immune active clamp circuit with minimum voltage control of the disconnection switch. FIG. 13 is similar to FIG. 12 except the 2^{nd} timing circuit. FIG. 13 comprises a V-detector (Voltage detector) 1302 which detects the state (on/off) of Vdd 406 in voltage domain whereas the 2^{nd} timing circuit of FIG. 12 detects the state (off/on) of Vdd 406 in time domain. The V-detector 1202 detects the value of the voltage at the Vdd line 406 and if it is above a certain value, the capacitor 1008 is connected and the first PMOS device 1202 can turn on. If the voltage at the Vdd-line 406 is below the certain value, the capacitor 1008 is disconnected and the first PMOS 1202 will be kept off. Note it is also possible that the capacitor 1008 is connected if the Vdd-line 406 is below a certain value and it will be disconnected if it is above a certain value. This value can, for instance, be a value larger than the normal operation supply, such that false triggering during normal operation is avoided.

FIG. 14 depicts an illustration of a circuit diagram 1400 of block diagram of the power protection clamp of FIG. 5. Specifically, FIG. 14 depicts an illustration of a circuit diagram of the supply noise immune active clamp circuit with maximum voltage control of the disconnection switch. The disconnection switch, first PMOS 1202 is switched OFF if the voltage of the Vdd of the HV domain 406a′ is above a certain voltage. This value is below the normal operation supply voltage. This again impedes triggering during normal operation. Note that in this case, the ESD clamp i.e. the PMOS 1002 must trigger at a voltage below the chosen disconnection switch turn off voltage. Although it might sound contradictory to create an ESD clamp 1002 to NOT trigger at high voltages, this is a useful approach to avoid latch up issues, while ESD protection can still be created. Because the gate of the first PMOS 1202 must be higher than its source (i.e. the source of the first PMOS 1202 between the Vdd 406a″ and the Vss 406b″ to disconnect the capacitor C 1008, the gate driver circuit must consist of device in a low voltage domain with a higher supply voltage. Thus, a simple solution exists when two voltage domains exist in the same chip as illustrated in FIG. 14. The clamping voltage of the PMOS device 1002 between Vdd 406a″ and Vss 406b″ in the low voltage domain must be below the switching voltage of the first inverter 1402 in the HV domain. If the clamping voltage is higher than the switching voltage, the core circuitry between Vdd 406a″ and Vssb 406b″ (not shown) will take most of the current since it is the lowest resistive path. If the clamping voltage is lower than the switching voltage, the ESD clamp, i.e., the PMOS 1002 will take the most current and prevent breaking down of the core circuitry (not shown). Additionally, a second inverter 1404 couples the Vdd 406a″ of LV to the control line 410 as shown in FIG. 14. So, when the Vdd 406a″ is at low voltage or 0 volts, the first inverter 1402 will convert it to high voltage which in inputted into the second inverter 1404. The second inverter 1404 will now convert the high voltage back to the low voltage which will cause the first PMOS 1202 to trigger the ESD clamp, i.e., the PMOS 1002. However, when the Vdd 406b″ is at high voltage, the first inverter 1402 will convert it to low voltage which is inputted into the second inverter 1404. The second inverter 1404 will now convert the low voltage back into high voltage which will cause the first PMOS 1202 to disable the ESD clamp, i.e., the PMOS 1002.

Since ESD consists of high currents, it is possible to create the disconnection switch such that it needs high currents to turn on. This disconnection switch (not shown) which requires high currents to turn on could preferably be added in FIG. 14 in combination with a voltage controlled disconnection switch.

Furthermore, the implementation shown in FIG. 14 for instance can preferably comprise adding an RC time circuit (not shown) in the HV domain to delay the switching of the first inverter.

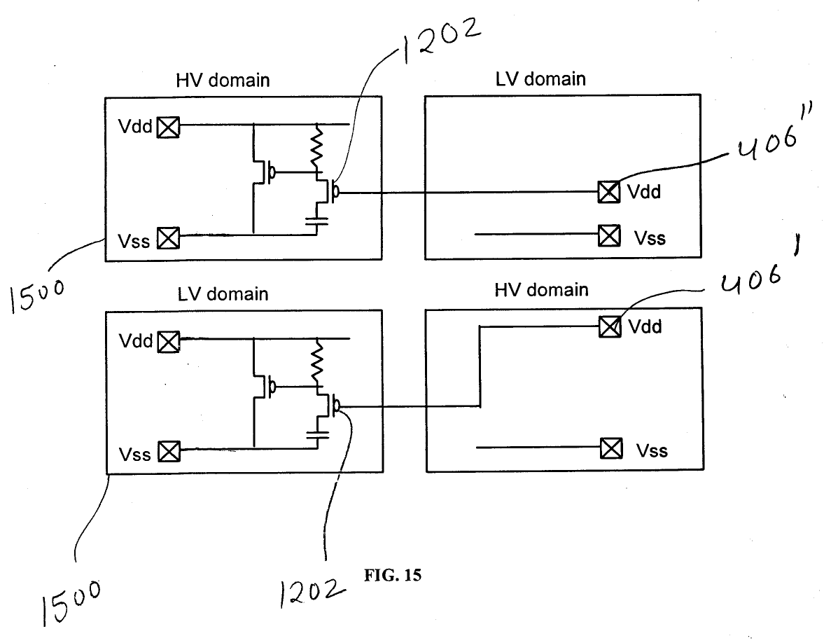

FIG. 15 shows the supply noise immune active clamp circuit 1500 using the state of another voltage domain to control the disconnection switch. In this simplified figure, it is assumed that the power supply from the low voltage domain can drive the HV PMOS in off state. If the power clamp 1500 is implemented in the LV domain, the potential Vdd 406′ from the HV domain can be used to disconnect the capacitor 1008 when both supplies are ON. A HV first PMOS device 1202 is prefer ably used to prevent gate problems occurring due the gate voltage on this first PMOS device 1202 being too high. If the power clamp 1500 is implemented in the HV domain, the potential Vdd 406″ from the LV domain can be used to disconnect the capacitor 1008 when both supplies are ON. A HV first PMOS device 1202 is preferably used to prevent gate problems occurring due the voltage over drain and gate on this first PMOS device 1202 being too high.

Although various embodiments that incorporate the teachings of the present invention have been shown and described in detail herein, those skilled in the art can readily devise many other varied embodiments that still incorporate these teachings without departing from the spirit and the scope of the invention.

1. An ESD protection circuit comprising:
an ESD clamp;
a trigger circuit coupled to said clamp, wherein said clamp and said trigger circuit are coupled to a first reference potential; and
a control line coupled to said trigger circuit; said control line coupled to a second reference potential;
wherein when power is supplied to said second reference potential, the control line disables said trigger circuit, and when power is not supplied to said second reference potential, the control line enables the trigger circuit.

2. The ESD protection circuit of claim 1 wherein the first reference potential is coupled to the second reference potential.

3. The ESD protection circuit of claim 1 wherein the control line is coupled to the second reference potential via a power detection circuit.

4. The ESD protection circuit of claim 1 wherein said ESD clamp comprises at least one of SCR, MOS transistor, bipolar transistor, and diode.

5. The ESD protection circuit of claim 1 wherein said trigger comprises a logic OR gate and an inverter, said logic OR gate having an input and an output with the output fed back into said input and into an input of the inverter.

6. The ESDC protection circuit of claim 5 wherein output of said inverter is coupled to the ESD clamp to provide a trigger signal to said clamp during ESD and when no power is supplied to the first reference potential.

7. The ESD protection circuit of claim 5 further comprises a capacitor coupled to the input of the inverter.

8. The ESD protection circuit of claim 3 wherein said power detection circuit comprises at feast one impedance.

9. The ESD protection circuit of claim 8 wherein said impedance comprises a resistor.

10. The ESD protection circuit of claim 1 wherein said trigger circuit comprises an impedance circuit.

11. The ESD protection circuit of claim 10 wherein said impedance circuit comprises a resistor.

12. The ESD protection circuit of claim 10 wherein said impedance circuit comprises a series connection of a resistor, a capacitor and a switch.

13. The ESD protection circuit of claim 14 wherein the switch is coupled to the control line.

14. The ESD protection circuit of claim 12 wherein the switch is a MOS device.

15. The ESD protection circuit of claim 14 wherein source and drain of the MOS device are coupled in series with the resistor and the capacitor to form a first timing circuit, said gate of said MOS device is coupled to the control line and a connection of the resistor, the capacitor and the switch is coupled to the ESD clamp.

16. The ESD protection circuit of claim 15 wherein the switch comprises an SCR.

17. The ESD protection circuit of claim 1 further comprising a second timing circuit coupled to the control line and coupled to the second reference potential.

18. The ESD protection circuit of claim 17 wherein said second timing circuit comprises a resistor and a capacitor connected in series.

19. The ESD protection circuit of claim 17 wherein said second timing circuit comprises a resistor and a voltage detector connected in series.

20. The ESD protection circuit of claim 1 wherein said trigger circuit comprise at least one MOS device and the control line disables the trigger circuit if the voltage at the control line line is below the threshold voltage of said MOS device and enables the trigger circuit when the voltage is higher than said threshold voltage.

21. The ESD protection circuit of claim 3 wherein said power detection circuit comprises at least one inverter with an input of said inverter connected to the first reference potential.
